(19) United States
(12) Patent Application Publication
(10) Pub. No.: US 2017/0076228 A1
(43) Pub. Date: Mar. 16, 2017

(54) Systems, Apparatus, and Methods For Reporting Event Data Over a Network

(71) Applicant: Khalil EMAMI, San Diego, CA (US)

(72) Inventor: Khalil EMAMI, San Diego, CA (US)

(21) Appl. No.: 15/140,508

(22) Filed: Apr. 28, 2016

Related U.S. Application Data
(60) Provisional application No. 62/153,170, filed on Apr. 27, 2015.

(51) Int. Cl. G06Q 10/02; H04L 29/08

(52) U.S. Cl. CPC G06Q 10/02; H04L 67/306; G06Q 50/16

(57) ABSTRACT

Apparatus, system and methods for reporting event data over a network, such as reporting e.g. check-in and check-out times of a buyer's real estate agents visiting listed properties associated with a seller's real estate agent using NFC, QR tags, RFID or other suitable technology is disclosed. The present invention can also be used in reporting a worker's check-in and check-out times at a particular location, or reporting a parent's drop-off or pick-up times of a child at school or daycare. A computerized apparatus is disclosed that comprises: a processor; a user interface; a network interface in data communication with the processor; a storage device in data communication with the processor; and a software process operative to run on the processor.

### CROSS REFERENCE TO RELATED APPLICATIONS

This application claims priority to U.S. Provisional Application Ser. No. 62/153,170, filed on Apr. 27, 2015 and entitled “REAL TIME CHECKIN AND CHECKOUT PROCEDURE FOR REAL ESTATE AGENTS,” which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Technical Field

The present invention relates generally to the field of computerized systems, apparatus, and networks. More specifically, the present invention relates in one exemplary aspect to computerized systems, apparatus, and methods for reporting event data over a network, such as e.g. check-in and check-out times of a buyer's real estate agent at properties listed by a seller's real estate agent.

2. Description of Related Technology

Tracking and reporting information over a network is a rapidly growing field, which is due in large part to significant advances in networking, electronic, and wireless technology integration, miniaturization, and performance. As such, tracking and reporting information over a computerized network, which was once beyond the realm of reasonable use can now be implemented with ease and minimal cost.

In the real estate industry, a buyer's agent typically has to schedule an appointment with a seller's agent before visiting a property listed by the seller's agent. However, a listed property may simply have a lockbox, which allows access by the buyer's agent without permission or appointment by the seller's agent; in which case, the standard practice is for the buyer's agent to leave his/her business card. Numerous problems exist in accurately and effectively communicating to the seller's agent whether a particular property has been visited by a buyer's agent, or whether this information is being conveyed at all. Furthermore, the overall security of a property listing may be compromised because the exact time and date that a particular agent enters or exits a particular property is unknown. Moreover, in the case of a very rural property listing, additional problems are present, such as e.g., lack of electrical power, lack of internet connectivity, or the need for tracking devices requiring batteries and other routine maintenance. Lastly, a buyer's agent should be able to communicate his/her check-in and check-out times to any other seller's agent, whether from the same organization or not, which gives rise to further problems related to the hosting of a centralized server and data repository owned by a single entity.

Currently, numerous solutions exist for timekeeping through the utilization of near field communication (“NFC”) technology, and/or Quick Response (“QR”) tags. For example, U.S. Pat. No. 8,321,246 to Shah, filed Sep. 28, 2011, entitled “Location check-in via short range communication,” discloses a system for obtaining location-based information from a target device using NFC technology, retrieving check-in information based on the location information obtained from the target device, and updating a user's status based on the retrieved information. United States Patent Publication No. 2014/0114824 to Kong et al., published Apr. 24, 2014, entitled “Method and apparatus for timekeeping,” discloses a system that utilizes a centralized database for recording an employee's clock-in and clock-out times via a camera, fingerprint scanner, NFC technology or QR tags. Badgebox (https://www.badgebox.com/index-en.html) discloses an electronic timekeeping cloud-based system that tracks clock-in and clock-out times. Simple in/out (https://www.simpleinout.com) discloses a time tracking system utilizing geo fencing and a mobile device's GPS capabilities to track when an employee enters or leaves the office.

Solutions also exist for tracking real estate leads or other data through use of virtual telephone numbers, NFC technology, or QR tags. For example, United States Patent Publication No. 2013/0297442 to Simons et al., published Nov. 7, 2013 and entitled “System and method for routing and tracking real estate leads,” discloses a system that associates a virtual telephone number to a real estate lead, which manages communication between a real estate agent and the real estate lead, and allows for lead routing decisions and analytic tracking. United States Patent Publication No. 2013/03003085 to Boucher et. al., published Nov. 14, 2013, entitled “Near Field Communication Tag Data Management,” discloses a system for enabling read/write operations between NFC devices at multiple levels of access authorization. CodeREADr™ (https://www.codereadr.com) and Barcodesinc (https://www.barcodesinc.com) discloses systems that can utilizes NFC technology or QR tags for collecting, tracking, and transmitting data over a network.

Various solutions also exist for identifying individuals who may be interested in receiving information about a particular property listing through use of a mobile device's location services, NFC technology, or QR tags. For example, United States Patent Publication No. 2011/0184873 to Wilson et. al., published Jul. 28, 2011, entitled “Methods and systems for transmitting location based agent alerts in a real estate application,” discloses a system for identifying one or more clients of a real estate agent that may be interested in a particular property, based upon the real estate agent's proximity to a listed property on the MLS directory.

Still further, numerous other solutions exist for identifying a location, tracking or controlling access to various devices or even opening locks through use of a mobile device's GPS capabilities, NFC technology, or QR tags. For example, U.S. Pat. No. 8,844,811 to Rogers et al., filed Jun. 4, 2013, entitled “System and method for controlling locks,” discloses a system and method for opening locks, which utilizes a handheld mobile device and QR tags. United States Patent Publication No. 2013/0214902 to Pineau et al., published Aug. 23, 2013, entitled “Systems and methods for networks using token based location,” discloses a computerized system utilizing a common interface for accessing, controlling, and managing multiple physical devices via the internet through NFC technology and/or QR tags. United States Patent Publication No. 2015/0039357 to Segal et al., published Feb. 5, 2015, entitled “Systems and Methods for Providing on Demand Business Resources,” discloses a method for on-demand business resource management utilizing a network and QR tags. A printed publication by Costa-Montenegro et al., entitled “QR-Maps: an Efficient Tool for Indoor User Location Based on QR-Codes and Google Maps,” IEEE, 1993, pp. 482-485 (2011), discloses an application that can be used with a mobile device to obtain a user location information indoors via QR tags via use of a location and map server.

The above prior art references to Wilson, Pineau, Boucher, Simons, Kong, Segal, Shah, Rogers, Costa-Montenegro, Badgebox, Barcodesinc, Simple in/out, CodeREADr™ and all other extraneous materials discussed herein are incorporated herein by reference in their entirety. Where a definition or use of a term in an incorporation reference is inconsistent or contrary to the definition of that term provided herein, the definition of that term provided herein applies and the definition of that term in the reference does not apply.

Based on the foregoing, there is still a need for improved systems, apparatus, and methods for reporting event data over a network, such as e.g. check-in and check-out times of a buyer's real estate agent at property listing associated with a seller's real estate agent through use of NFC technology and/or QR tags, or other suitable technology.

### SUMMARY OF THE INVENTION

In a first aspect, a computerized user apparatus is configured to receive a plurality of event data from at least a first user device via at least one network entity is disclosed.

In one embodiment, the apparatus comprises: a processor; a user interface; a network interface in data communication with the processor; a storage device in data communication with the processor; and a software process operative to run on the processor.

In one variant, the software process comprises a plurality of instructions which are configured to, when executed: register a first user profile associated with at least a first one of a plurality of identification information relating to a first user; register a first property profile associated with the first user profile; receive via the network entity a first one of the plurality of event data associated with the first property profile, wherein the first one of the plurality of event data, is collected by a second user, via the first user device by at least one data capture method; and receive via the network entity a second one of the plurality of event data associated with the first property profile, wherein the second one of the plurality of event data is collected by a second user via the first user device by the at least one data capture method.

In a second aspect, a method of receiving a plurality of event data from at least a first user device via at least one network entity is disclosed.

In a second embodiment, the method comprising: registering a first user profile associated with at least a first one of a plurality of identification information relating to a first user; registering a first property profile associated with the first user profile; receiving at the storage device via the network entity a first one of the plurality of event data associated with the first property profile, wherein the first one of the plurality of event data, is collected by a second user, via the first user device by at least one data capture method; and receiving at the storage device via the network entity a second one of the plurality of event data associated with the first property profile, wherein the second one of the plurality of event data is collected by a second user via the first user device by the at least one data capture method.

Other features and advantages of the present invention will immediately be recognized by persons of ordinary skill in the art with reference to the attached drawings and detailed description of exemplary embodiments as given below, along with the accompanying drawings in which like numerals represent like components.

### BRIEF DESCRIPTION OF THE DRAWINGS

FIG. 1 is a functional block diagram illustrating one exemplary embodiment of a system for reporting check-in and check-out times useful with the present invention.

FIG. 2 is a functional block diagram illustrating another exemplary embodiment of a system for reporting check-in and check-out times useful with the present invention.

FIG. 3A is a screen shot illustrating one exemplary embodiment of a software application user interface used for displaying event data related to property listings associated with a particular seller's agent useful with the present invention.

FIG. 3B is screen shot illustrating another exemplary embodiment of a software application user interface used for displaying event data relating to a specific property listing associated with a seller's agent useful with the present invention.

FIG. 3C is a screen shot illustrating yet another exemplary embodiment of a software application user interface used for displaying event data relating to a particular buyer's agent visiting registered properties useful with the present invention.

FIG. 3D is a screen shot illustrating yet another exemplary embodiment of a software application user interface used for displaying registered property listings associated with a particular seller's agent useful with the present invention.

FIG. 3E is a screen shot illustrating still another exemplary embodiment of a software application user interface used for displaying a registered user's profile and associated property listings useful with the present invention.

FIG. 4 is a logical flow diagram illustrating one exemplary process of creating a user profile related to a seller's agent and associating a particular property listing to the user profile via address entry useful with the present invention.

FIG. 5 is a logical flow diagram illustrating another exemplary process of creating a user profile related to a seller's agent and associating a particular property listing to the user profile via location services of a seller's agent user device useful with the present invention.

FIG. 6 is a logical flow diagram illustrating one exemplary process of retrieving event data associated with a registered property profile or listing useful with the present invention.

FIG. 7 is a logical flow diagram illustrating one exemplary process of reporting a buyer agent's check-in and check-out times relating to a listed property associated with a seller's agent useful with the present invention.

FIG. 8 is a schematic illustrating the steps of a method of receiving a plurality of event data from at least a first user device via at least one network entity useful with the present invention.

All FIGS. ©Copyright 2016. Khalil Emami. All rights reserved.

### DETAILED DESCRIPTION OF THE INVENTION

Exemplary embodiments of the systems, apparatus and methods of the present invention are now described in detail. Reference is made to the drawings, wherein like numerals refer to like parts throughout. It is noted that while the systems, apparatus, and methods of the present invention disclosed herein are described primarily with respect to reporting event data related to a buyer's real estate agent (buyer's agent) visiting a registered property profile or listing associated with a seller's real estate agent (seller's agent), certain aspects of the present invention may be readily adapted to other types of industries and environments, including but not limited to reporting a worker's check-in and check-out times at a particular location, e.g. reporting a plumber's check-in and check-out times at a particular high-rise condo building, or reporting a parent's drop-off or pick-up times of a child at school or daycare. Hence, a myriad of other applications of the present invention are contemplated.

As used herein, the term “application” is meant to generally refers to a unit of executable software that implements a certain functionality or theme. The themes of applications vary broadly across any number of disciplines and functions, and one application may have more than one theme. The unit of executable software generally runs in a predetermined environment; for example, the unit could comprise a downloadable application.

As used herein, the terms “user device,” “client device,” and “mobile device,” is meant to refer devices, with or without location services, such as including, but not limited to handheld computers, PDAs, personal media devices (PMDs), mobile phones, smartphones, tablet computers, wearable devices, with or without GPS or location services.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.), Binary Runtime Environment (e.g., BREW), and the like.

As used herein, the term “event data” or “event” is meant to include any information or data related to a change in state or information related to a registered user's profile or registered property listing (otherwise known as a registered property profile), including, without limitation, a buyer's real estate agent checking-in or checking-out at a particular property listing associated with a particular seller's real estate agent, a worker's clock-in or clock-out times related a particular location, building, organization, location information, a parent's drop-off or pick-up time of a child at school or daycare. Event data includes also information or data associated with a registered user's profile or registered property profile or listing, including without limitation, name, company name, phone number, email linked to user profile, event information, time information, location information, tag information, property listing information, physical property address, serial number information, or any other relevant information.

As used herein, the term “network” is meant to refer generally to any type of telecommunications or data network including, without limitation, hybrid fiber coax (HFC) networks, fiber networks (e.g., FTTH, Fiber-to-the-curb or FTTC, etc.), satellite networks, and data networks (including MANs, WANs, LANs, WLANs, internets, and intranets).

As used herein, the term “server” is meant to refer generally to any computerized component, system or entity regardless of form which is adapted to provide data, files, applications, content, or other services to one or more user devices or entities on a computer network.

### Exemplary Systems and Apparatus

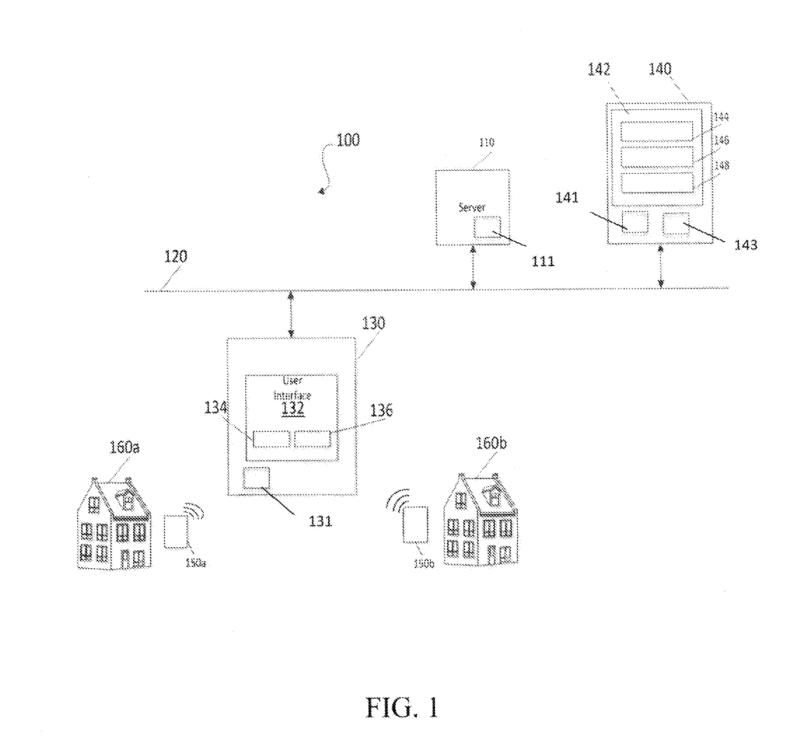

FIG. 1 depicts a functional block diagram of one exemplary embodiment of a system for reporting event data (e.g. check-in and check-out times of a buyer's real estate agent at property listing associated with a seller's agent), according to the present invention. One of ordinary skill in the art will appreciate that system 100 and/or network 120 may include, without limitation, many additional components not shown, such as e.g. one or more servers, user devices, client devices, mobile devices, network interface controller (NICs), repeaters, hubs, bridges, switches, routers, modems, and firewalls, network links including wired and wireless technologies, hybrid fiber coax (HFC) networks, fiber networks (e.g., FTTH, Fiber-to-the-curb or FTTC, etc.), satellite networks, and any other data networks, including MANs, WANs, LANs, WLANs, internets, and intranets.

As shown in FIG. 1, exemplary system 100 comprises network 120, server 110 having a network interface 111 for communication with devices 130 and 140. One of ordinary skill in the art will appreciate that the total number of user devices 130 and 140 capable of communicating with network 120 is limited only by the capacity of network 120 to convey data from one location in the network to another.

In exemplary embodiments, user device 130 includes a buyer agent application (not shown), which can be downloaded or installed on user device 130, and stored within a storage device (not shown) is configured to display user interface 132 capable of allowing a buyer's agent to log or report particular event data to seller agent's device 140. User device 130 is configured to communicate with at least one entity (e.g. server 110) on network 120, via at least one network interface 131. In one variant, user device 130 is configured to allow a buyer's agent to check-in and check-out and then log or report such event data to user device 140 regarding buyer agent's check-in and check-out times with respect to property listings 160a and 160b, via reading or interacting with tags 150a and 150b affixed to or otherwise associated with property listing 160a and 160b, respectively. It is further contemplated that seller agent's user device 140 includes a seller agent application (not shown) configured to display a user interface 143 capable of allowing a seller's real estate agent to view particular event data related to one or more buyer's agents. Seller agent application, which can be downloaded or installed on user device 140, and stored within storage device 142 comprises data entities (or modules) 144 (corresponding to one or more user profiles), 146 (corresponding to one or more registered property profiles associated with a particular user profile), and 148 (corresponding to various items of event data, such as e.g. buyer agent's check-in and check-out times related to property listing 160a and 160b associated with seller's agent, and received from user device 130 over network 120 via server 110). User device 140 is configured to communicate with at least one entity (e.g. server 110) on network 120, via at least one network interface 141.

In exemplary embodiments, server 110 is an email server (otherwise known as a mail transfer/transport agent (MTA), a mail router or other similar device) and includes, without limitation, email servers such as e.g. Microsoft Exchange, Exim and send mail, configured to receive incoming emails from user device 130 for forwarding to user device 140 via network 120, according to a set of user defined rules. It is contemplated that server 110 may include, without limitation, a processor, a storage device for storing incoming or outgoing emails, a software process operative to run on the processor, comprising a plurality of instructions that are configured to, when executed, determine how server 110 routes particular incoming and outgoing messages, and network interfaces and communication modules that handle the transfer of incoming and outgoing emails to and from other email servers and clients, or to store such messages for later forwarding, downloading, or pushing to seller agent's user device 140 according to a set of user configurable rules. It is contemplated that server 110 can use SMTP (Simple Mail Transfer Protocol) or ESMTP (extended SMTP) for sending emails, and either POP3 (Post Office Protocol 3) or IMAP (Internet Message Access Protocol) for receiving emails. However, in other variants, it is contemplated that server 110 can be a web server, application server, real-time communication server, FTP server, collaboration server, list server, telnet server, virtual server, or any other suitable type of communication server.

It is contemplated that user devices 130 and 140 can include, without limitation, any handheld devices, computers, PDAs, personal media devices (PMDs), mobile phones, smartphones, tablet computers, wearable devices, with or without GPS or location services, which are capable of interacting with NFC devices, QR tags, RFID devices, beacon technology, or other suitable technology, and which are capable of communicating with a network via wired or wireless technology, including, without limitation, satellite, microwave, infrared (IR), IEEE 802.15.4 (ZigBee), IEEE 802.11—WiFi, IEEE 802.15.1—Bluetooth and Bluetooth Low Energy (BLE), and IEEE 802.16—WiMax.

As shown in FIG. 1, user device 130 is capable of interacting with tags 150a and 150b which have been installed or otherwise associated with property listing 160a and 160b respectively, via NFC technology, QR tags, RFID devices, beacon technology, or other suitable technology. One of ordinary skill in the art will appreciate that the total number of tags and property listing that can used in conjunction with the present invention is unlimited.

In one exemplary embodiment, tags 150a and 150b contain information related to a particular property listing 160a and 160b, respectively, including, without limitation, property address data, data related to a particular seller's real estate agent, date property listed, type of tag, a unique serial number, and any other suitable information associated with a particular property listing. It is contemplated that tags 150a and 150b can include, without limitation, any type of passive or active barcode technology, NFC signaling technology, including NFC-A, NFC-B, and NFC-F technology, any type of QR codes or tag technology, RFID technology, or other suitable technology.

As shown in FIG. 1, user device 130 includes a buyer agent application (not shown) configured to display user interface 132 capable of allowing a buyer's agent to issue a command related to a particular event data (e.g. check-in command 134 or check-out command 136) and thereby log or report such event data to seller agent's user device 140 over network 120 via server 110. In exemplary embodiments, such event data is transmitted over network 120 to seller agent's user device 140 in the form of an email from buyer agent's user device 130, whereby the buyer agent's email address is associated with a user profile linked to said buyer's agent. It is contemplated that the user profile associated with a particular buyer's real estate agent is stored on the user device 130, and can comprise buyer agent identification information, which includes, but is not limited to, buyer agent's name, company name, phone number, email address, and any other relevant information associated with buyer's agent. One of ordinary skill in the art will appreciate that the total number of buyer agent's user profiles that can registered in conjunction with the present invention is unlimited, and that such buyer agent's registered user profile can be stored at various locations within network 120.

Further, as shown in FIG. 1, seller agent's user device 140 includes a seller agent application (not shown) contained within storage device 142 comprising data entities (or modules) 144, 146, and 148 for storing user profile information, associated property listing information, or other event data, respectively. It is contemplated that the user profile associated with a particular seller's real estate agent can comprise seller agent identification information include, without limitation, seller agent's name, company name, phone number, email address, property listings associated with said seller's agent, such that the seller agent's email address is associated with a user profile linked to said seller's agent. One of ordinary skill in the art will appreciate that the total number of seller agent's user profiles that can be registered, and the total number of property listing associated with said seller agent's user profile in conjunction with the present invention is unlimited, and that such seller agent's registered user profile can be stored at various locations within network 120.

In exemplary embodiments, before transmission of any event data (e.g. check-in time, check-out time, property listing data) associated with tags 150a and 150b affixed to or otherwise associated with property listing 160a and 160b, respectively, user device 130 prompts, buyer's agent with several options, including, without limitation, selection of a data capture method via QR, NFC, RFID, use of location services, or other suitable data capture method and options related thereto. For example, if property listing 160a has a QR tag affixed to or is otherwise associated therewith, buyer agent's must select the QR tag option for this operation. Following this selection, buyer's agent is prompted with additional prompts, including without limitation, check-in command 134, check-out command 136, or other event data commands, all of which trigger the creation of an email capturing said event data (e.g. capture of check-in or check-out information, location information, registered user information, registered property profile or listing information associated with a particular seller's agent), which is then transmitted over network 120 via server 110 to user device 140 and stored with storage device 142 and the appropriate data entities (or modules)144, 146, and 148.

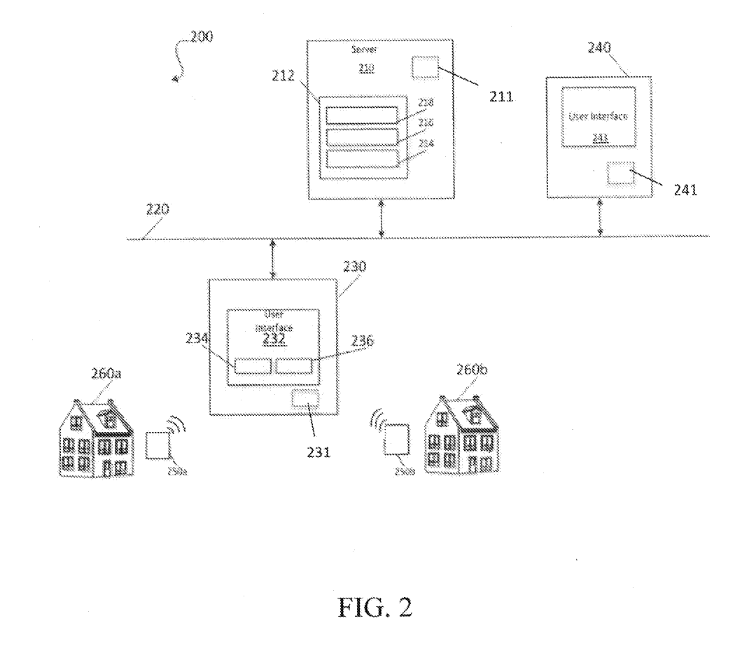

FIG. 2 depicts a functional block diagram of an alternative embodiment of a system for reporting event data (e.g. check-in and check-out times of a buyer's real estate agent at property listing associated with a seller's agent), according to the present invention. As shown in FIG. 2, exemplary system 200 comprises network 220, server 210 having network interface 211 for communicating with user devices 230 and 240. User device 230 includes a buyer agent application (not shown) contained within a storage device (not shown) configured to display user interface 232 capable of allowing a buyer's real estate agent to log or report particular event data to seller agent's device 240. User device 230 is configured to communicate with at least one entity (e.g. server 210) on network 220, via at least one network interface 231. In one variant, user device 230 is configured to allow a buyer's agent to check-in and check-out and then log or report such event data to user device 240 regarding buyer agent's check-in and check-out times with respect to property listings 260a and 260b, via reading or interacting with tags 250a and 250b affixed to or otherwise associated with property listing 260a and 260b, respectively. It is further contemplated that user device 240 includes a seller agent application (not show) configured to display a user interface 243 capable of allowing a seller's real estate agent to view particular event data related to one or more buyer's agent. User device 240 is configured to communicate with at least one entity (e.g. server 210) on network 220, via at least one network interface 241.

It is contemplated that server 210 is an email server, which includes, without limitation, a processor, a storage device 212 comprising data entities (or modules) 214 (corresponding to one or more user profiles), 216 (corresponding to one or more registered property profiles or listing associated with a particular user profile), and 218 (corresponding to various items of event data, such as e.g. buyer's agent check-in and check-out times related to property listing 260a and 260b associated with seller's agent, and received from user device 230 over network 220 via server 210), a software process operative to run on the processor, comprising a plurality of instructions that are configured to, when executed, determine how server 210 routes particular incoming and outgoing messages, and network interfaces and communication modules that handle the transfer of incoming and outgoing emails to and from other email servers and clients, or to store such messages for later forwarding, downloading, or pushing to seller agent's user device 240 according to a set of user configurable rules.

It is contemplated that user devices 230 and 240 can include, without limitation, any handheld devices, computers, PDAs, personal media devices (PMDs), mobile phones, smartphones, tablet computers, wearable devices, with or without GPS or location services, which are capable of interacting with NFC devices, QR tags, RFID devices, beacon technology devices, or other suitable technology, and which are capable of communicating with a network via wired or wireless technology, including, without limitation, satellite, microwave, infrared (IR), IEEE 802.15.4 (ZigBee), IEEE 802.11—WiFi, IEEE 802.15.1—Bluetooth and Bluetooth Low Energy (BLE), and IEEE 802.16—WiMax.

As shown in FIG. 2, user device 230 is capable of interacting with tags 250a and 250b which have been installed or otherwise associated with property listing 260a and 260b respectively, via NFC technology, QR tags, RFID devices, beacon technology, or other suitable technology. In one exemplary embodiment, tags 250a and 250b contain information related to a particular property listing 260a and 260b, respectively, including, without limitation, property address data, data related to a particular seller's real estate agent, date property listed, type of tag, and any other useful information associated with a particular property listing. It is contemplated that tags 250a and 250b can include, without limitation, any type of passive or active barcode technology, NFC signaling technology, including NFC-A, NFC-B, and NFC-F technology, any type QR codes or tag technology, RFID technology, or other suitable technology.

As shown in FIG. 2, user device 230 includes a buyer agent application (not shown) configured to display user interface 232 capable of allowing a buyer's real estate agent to issue a command related to a particular event data (e.g. check-in command 234 or check-out command 236) and thereby log or report such event data for storage at server 210, and pushing such event data to seller agent's user device 240 over network 220 according to a set of user configurable rules.

In exemplary embodiments, such event data is transmitted over network 220 to seller agent's user device 240 in form of an email from buyer agent's user device 230, whereby the buyer agent's email address is associated with a user profile linked to said buyer's agent. It is contemplated that the user profile associated with a particular buyer's real estate agent is stored on user device 230, and can comprise information, which includes but is not limited to buyer agent's name, company name, phone number, email address, and any other relevant information associated with the buyer's agent. One of ordinary skill in the art will appreciate that the total number of buyer agent's user profiles that can be registered in conjunction with the present invention is unlimited, and that such buyer agent's registered user profile can be stored at various locations within network 220, such as at server 210. It is also contemplated that the user profile associated with a particular seller's real estate agent can include, without limitation, seller agent's name, company name, phone number, email address, property listings associated with said seller's agent, such that the seller agent's email address is associated with a user profile linked to said seller's agent. One of ordinary skill in the art will appreciate that the total number of seller agent's user profiles that can registered, and the total number of property listing associated with said seller agent's user profile in conjunction with the present invention is unlimited, and that such seller agent's registered user profile can be stored at various locations within network 220, such as server 210.

In exemplary embodiments, before transmission of any event data (e.g. check-in time, check-out time, property listing data) associated with tags 250a and 250b affixed to or otherwise associated with property listing 260a and 260b, the buyer agent's user device 230 is prompted with several options, including, without limitation, selection of data capture method via QR, NFC, RFID, use of location services, or other suitable data capture method and options related thereto. For example, if property listing 260b has a NFC tag affixed to or is otherwise associated therewith, buyer agent's user device 230 must select the NFC tag option for this operation. Following this selection, buyer's agent is prompted with additional prompts, including without limitation, check-in command 234, check-out command 236, or other event data commands, all of which trigger the creation of an email capturing said event data, and which is then transmitted over network 220 to server 210 for forwarding or pushing to seller agent's user device 240 according to a set of user configurable rules.

### Exemplar Application User Interface

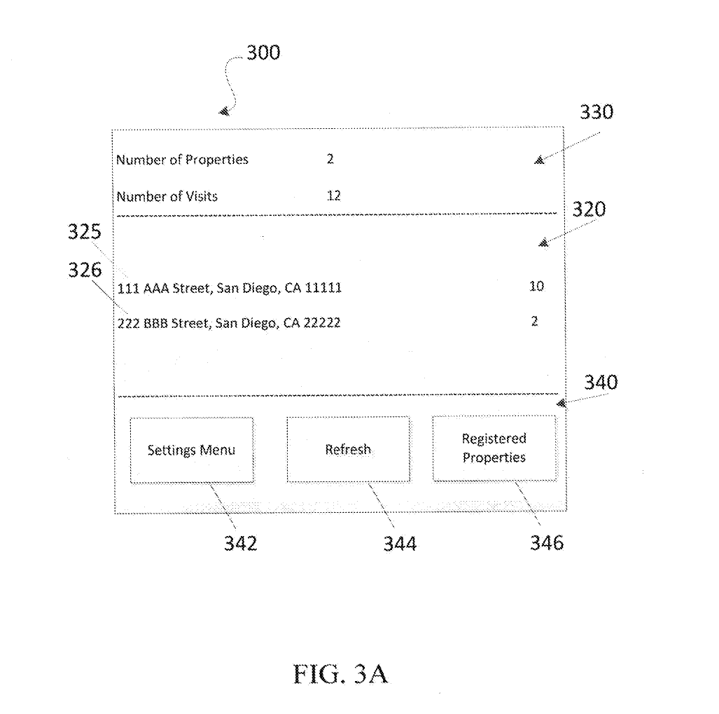

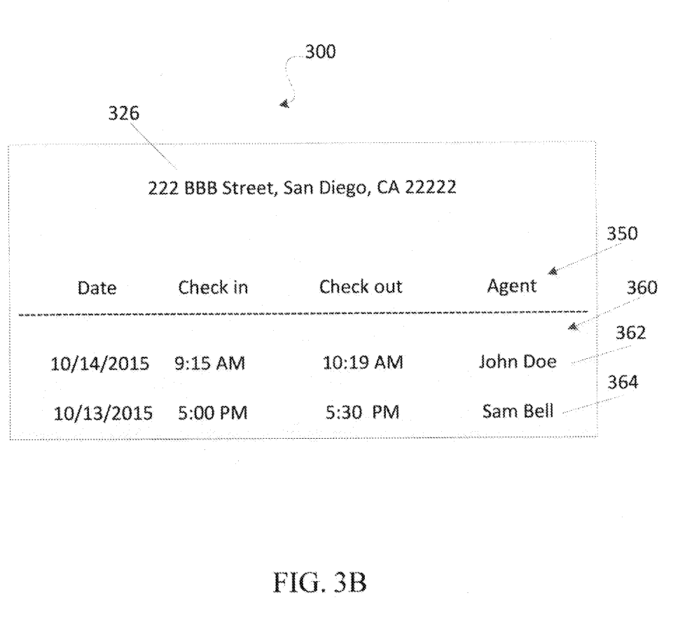

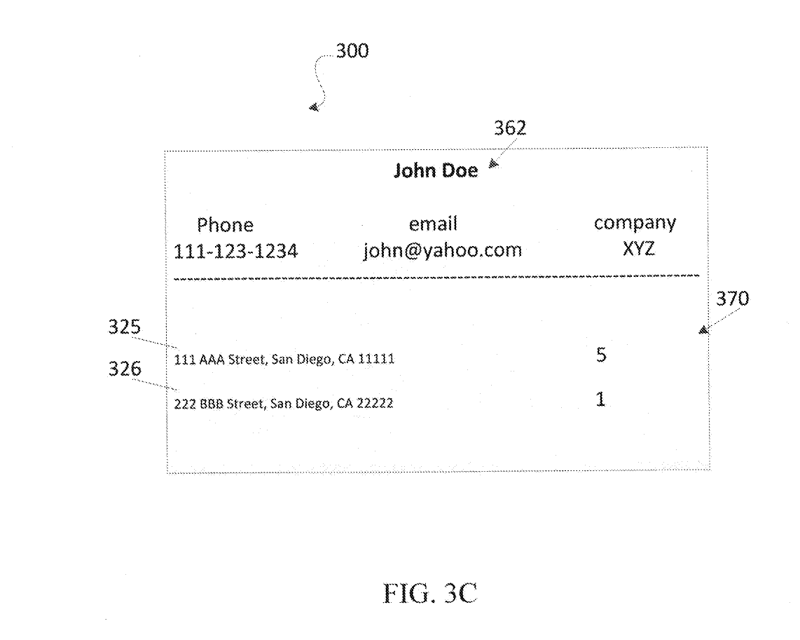

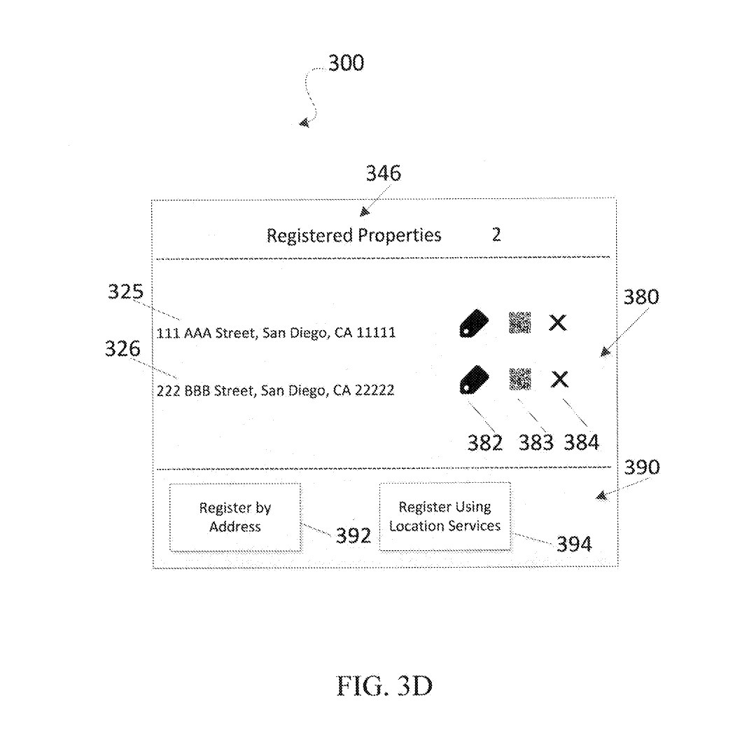

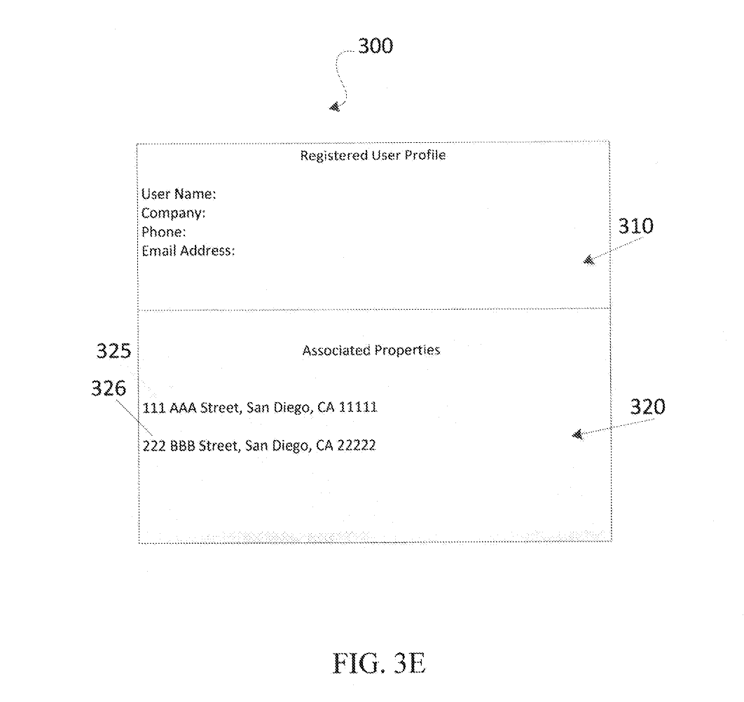

FIGS. 3A-3E depict screen shots of exemplary embodiments of a software application user interface useful in accordance with the present invention.

FIG. 3A depicts a screen shot illustrating one exemplary embodiment of a software application user interface used for displaying event data (e.g. total number of visits, check-in, or check-outs) related to all property listings associated with a particular seller's agent. As shown in FIG. 3A, exemplary user interface 300, in section 320, displays event data associated with a particular seller's agent with respect to each registered property listing (e.g. total number of visits, check-in, or check-out events for registered property listing 325 and 326). User interface 300, in section 330, displays the total number of registered properties associated with a particular seller's agent and the total number of events related to all property listing (e.g. total visits, check-in, or check-out events by one or more buyer's agents for all registered property listing associated with a specific seller's agent). It is contemplated, that if no event data exists for a specific property listing, then such property listing is not displayed in section 320. Further, as shown in FIG. 3A, this particular seller's agent has a total of 2 registered properties having a combined event total of 12 events. In this example, registered property listing 325 indicates that 10 events occurred in relation to said property listing having a physical address of 111 AAA Street, San Diego Calif. 11111. Registered property listing 326 indicates that 2 events occurred in relation to said property listing having a physical address of 222 BBB Street, San Diego Calif. 22222. Each of the property listing 325 and 326 can be selected to view more detailed event data related to each property listing.

FIG. 3B depicts another screen shot of an exemplary embodiment of a software application user interface 300 used for displaying different categories of event data, in section 350 (e.g. date, check-in time, check-out time, and agent) relating to a specific property listing 326 (e.g. 222 BBB Street, San Diego Calif. 22222), and for displaying said specific event data related to each category in section 360 (e.g. on 10/14/2015 buyer's agent John Doe 362 checked-in at 9:15 am and checked-out at 10:19 am, and on 10/13/15 buyer's agent Sam Bell 364 checked-in at 5:00 pm and checked-out at 5:30 pm). Each of the entries in section 360 can be selected to view additional details.

FIG. 3C depicts another screen shot of one exemplary embodiment of a software application user interface 300 used for displaying event data (in section 370) related to a specific buyer's agent 362 (e.g. John Doe and related user profile information, such as phone, registered email, and company name) relating to all registered property listings or profiles visited and the total number of visits (e.g. property listing 325 depicts 5 visits and property listing 326 depicts 1 visit).

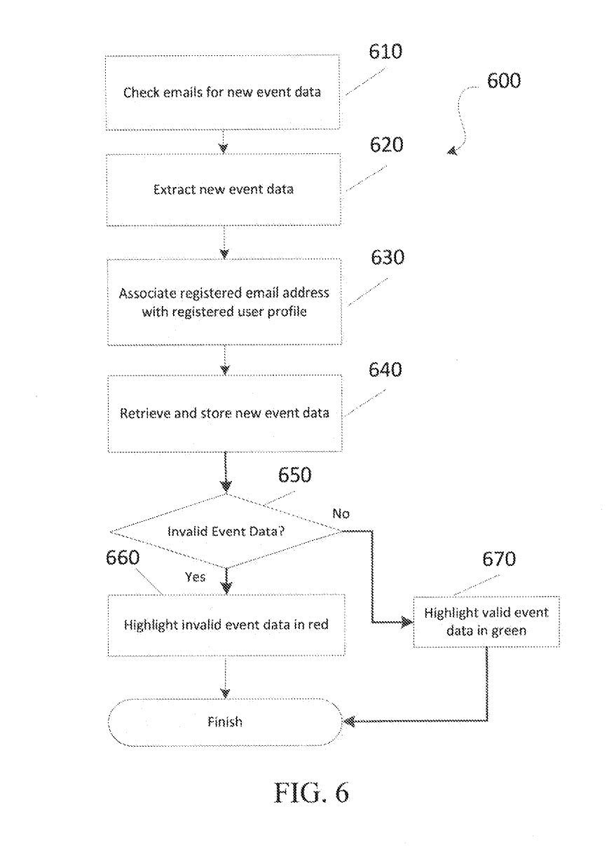

Turning back to FIG. 3A, software application user interface 300, in section 340, displays various user selectable buttons (e.g. setting menu button 342, refresh button 344, and registered properties button 346). Setting menu button 342 when selected, presents additional user configurable options, including without limitation access to a registered user's profile and associated registered property profiles or listings (i.e. property profiles 325 and 326), as shown in FIG. 3D and FIG. 3E, or provision of data export to an administrator of the mail server 210 (as shown in FIG. 2). Refresh button 344, in section 340, when selected, initiates an operation in seller agent's user device 140 (as shown in FIG. 1) to fetch all of the latest emails according to the steps as shown and described in FIG. 6. Registered properties button 346, when selected, provides access to the total number of registered property profiles (e.g. 325 and 326), a registration process for registering unregistered property listing that seller's agent desired to associated with said seller agent's user profile.

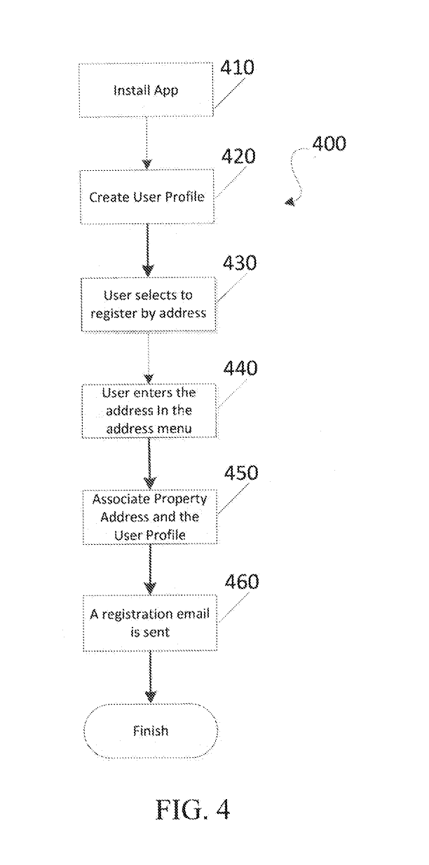

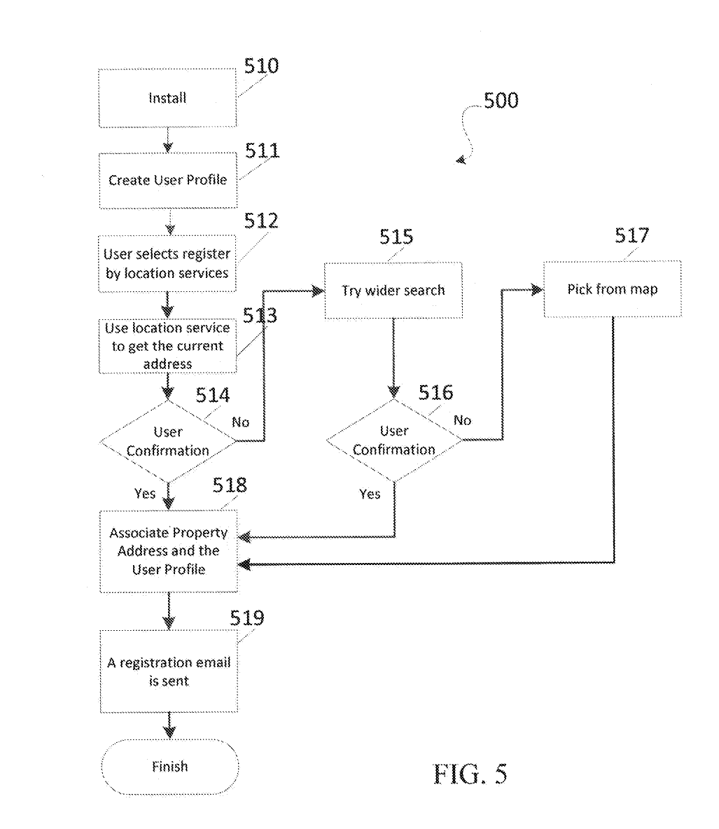

FIG. 3E depicts a screen shot of one exemplary embodiment of a software application user interface 300, which displays, in section 310, a registered user profile associated with a particular seller's agent who installed the application (e.g. display of user name, company, phone, and email address), and which displays, in section 320 the physical address information related to each of the registered property listings associated with said particular user profile. It is contemplated that associating a specific property profile or listing to a particular user profile can occur in two ways, as will be discussed in further detail in FIGS. 4 and 5.

FIG. 3D depicts yet another screen shot illustrating one exemplary embodiment of a software application user interface 300 which displays the total number of registered properties associated with a particular seller's agent (e.g. total of 2 registered property listing 325 and 326), and which allows, in section 390, for a seller's agent to register new property listings via buttons 392 (register by address) and 394 (register using location services) as will discussed in further detail in FIGS. 4 and 5. As shown in FIG. 3D, in section 380, user interface 300, also provides for selection of various user configuration options related to each registered property profile via icons 382, 383, and 384. For example, NFC tag icon 382, if selected, starts a procedure for encoding a NFC tag associated with a specific property listing (e.g., property listing 325 and 326), which may consist of writing information to the NFC tag imported from a particular seller agent's user profile, including but not limited to a registered email address, registered physical property address, or any other unique ID. QR code icon 383, if selected, starts a procedure for creating a QR code associated with a specific property listing (e.g., property listing 325 and 326), which may consist of writing information to the QR tag that is imported from a particular seller agent's user profile, including but not limited to a registered email address, registered physical property address, or any other unique ID. X icon 384, if selected, starts a procedure for deleting and/or otherwise releasing a specific registered property profile or listing from the system, such as when for example, a property is sold and no longer on the market, or the seller's real estate agent is no longer authorized to list the property for sale.

### Exemplary Methods

FIG. 4 depicts a logical flow diagram illustrating one exemplary method 400 for registering a new property profile or listing via address registration. At step 410, seller's agent downloads and installs seller agent application. At step 420, seller's agent creates a user profile, which includes, without limitation, name, company, phone, and desired email to be linked to the user profile. At step 430, seller's agent selects registration via address. At step 440, seller's agent enters the appropriate information relating to the property listing to be registered to the system (i.e. creation of property profile), which includes, without limitation, entry of a physical address of the property o10 to be registered to the system. At step 450, the seller agent application associates the seller agent's user profile with the property profile created in step 440. At step 460, a registration email is transmitted, which constitutes registration to the system of a seller user profile associated with a specific property profile.

FIG. 5 depicts a logical flow diagram illustrating one exemplary method 500 for registering a new property listing via location services. At step 510, seller's agent downloads and installs seller agent application. At step 511, seller's agent creates a user profile, which includes, without limitation, name, company, phone, and desired email to be linked to the seller's user profile. At step 512, seller's agent selects registration via location services to register the new property listing to the system (i.e. creation of property profile). At step 513, the application utilizes the location services of the seller agent's user device to obtain a physical address of the property listing to be registered based on the current location of the seller's user device. At step 514, the seller agent application prompts the user to confirm if the physical address is correct. If the address is correct the application proceeds to step 518. At step 515, if the address is not found or incorrect, the application tries a wider search to identify the correct address. At step 516, the application prompts the user to confirm if the new address is correct. If the new address is correct, the application proceeds to step 518. At step 517, if the address is still not found or incorrect, the application prompts the user to select an address from a map. At step 518, the seller agent application associates the seller agent's user profile with the property profile created in step 513. At step 519, a registration email is transmitted, which constitutes registration to the system of a seller's user profile associated with a specific property profile.

FIG. 6 depicts a logical flow diagram illustrating one exemplary method 600 for retrieving and storing event data (e.g. check-in and check-out times) in a database contained within a storage device. It is contemplated that the retrieval and storage of event data can be user initiated or automatically occur on seller agent application launch. At step 610, seller agent application accesses a mail server and checks for new emails containing event data (e.g. check-in and check-out times). At step 620, if new emails exist, the seller agent application extracts the new event data. At step 630, the seller agent application associates the registered email address with the registered user profile. At step 640, the application retrieves and stores the new event data in either a local database hosted on the seller's agent device or on a remote server. At step 650, the seller agent application validates the event data, such as by comparing the location of the seller agent's user device with the address for the registered property profile or listing. At step 660, if the event data is invalid, the application highlights the invalid event data (e.g. in red). At step 670, if the event data is valid, the application highlights the event data (e.g. in green).

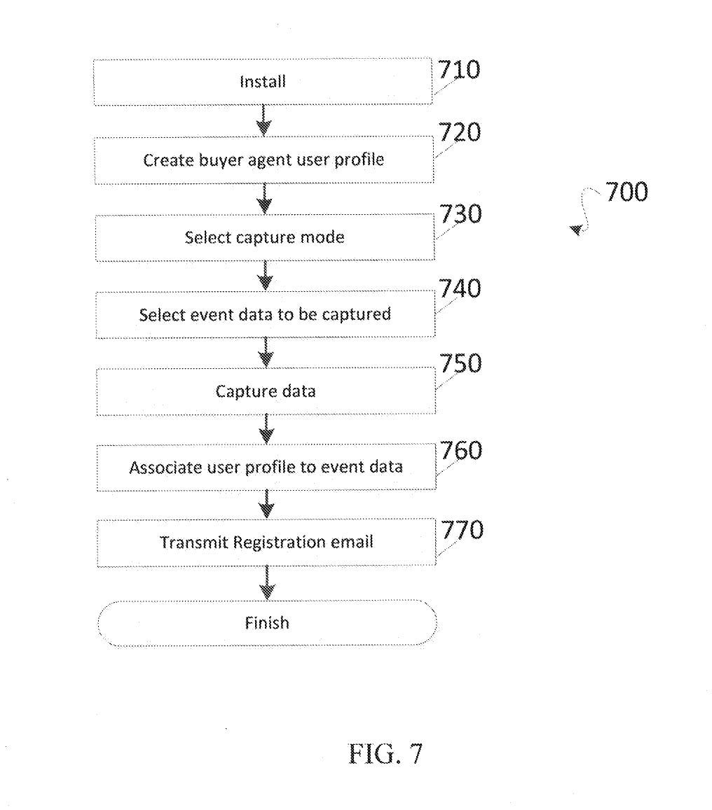

FIG. 7 depicts a logical flow diagram illustrating one exemplary method 700 for transmitting event data (e.g. check-in and check-out times related to a buyer agent visiting a property listing associated with a particular seller agent) from a buyer agent application to a seller agent application. At step 710, buyer's agent downloads and installs buyer agent application. At step 720, buyer's agent creates a user profile stored on buyer agent user device, which includes, without limitation, name, company, phone, and desired email to be linked to said buyer agent user profile. At step 730, buyer's agent selects the type of data capture to be employed, which includes but not limited to capture via NFC, QR, RFID, location services, or other suitable technology, depending on the type of tag affixed to or otherwise associated with a registered property listing. At step 740, buyer's agent selects the type of event data to be logged (e.g. check-in or check-out command or other event data command). At step 750, buyer agent application captures the event data via e.g. NFC, QR code, RFID, or determination through location services. At step 760, buyer agent application associates the buyer agent's user profile with the captured event data. At step 770, a registration email is transmitted, which constitutes registration to the system of a buyer agent user profile associated with a specific event data.

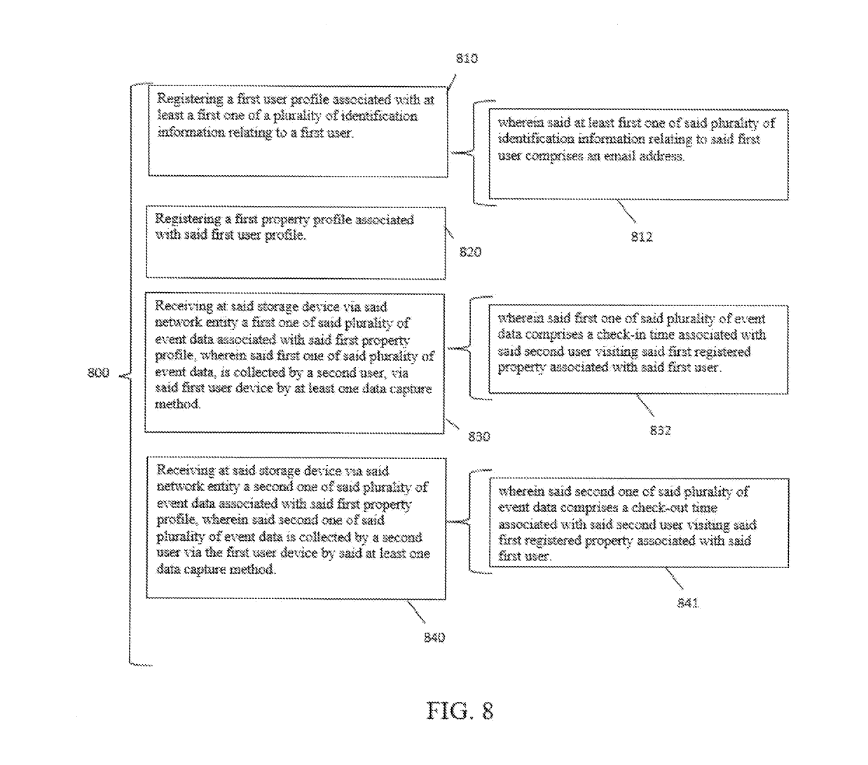

FIG. 8 depicts a schematic illustrating the steps of a method of receiving a plurality of event data from at least a first user device via at least one network entity useful with the present invention. At step 810, the method registers a first user profile associated with at least a first one of a plurality of identification information relating to a first user. In one variant, as shown in step 812, the at least first one of the plurality of identification information relating to the first user comprises an email address. At step 820, the method registers a first property profile associated with the first user profile. At step 830, the method receives at the storage device via the network entity a first one of the plurality of event data associated with the first property profile, wherein the first one of the plurality of event data, is collected by a second user, via the first user device by at least one data capture method. In another variant, as shown in step 832, the first one of the plurality of event data comprises a check-in time associated with the second user visiting the first registered property associated with the first user. At step 840, the method receives at the storage device via the network entity a second one of the plurality of event data associated with the first property profile, wherein the second one of the plurality of event data is collected by a second user via the first user device by the at least one data capture method. In yet another variant, as shown in 841, the second one of the plurality of event data comprises a check-out time associated with the second user visiting the first registered property associated with the first user.

While the above detailed description has shown, described, and pointed out novel features of the invention as applied to various embodiments, it will be understood that various omissions, substitutions, and changes in the form and details of the systems and methods illustrated may be made by those skilled in the art without departing from the invention. The description is in no way meant to be limiting, but rather should be taken as illustrative of the general principles of the invention. The scope of the invention should be determined with reference to the claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A computerized user apparatus, configured to receive a plurality of event data from at least a first user device via at least one network entity, said apparatus comprising:
a processor,
a user interface;
a network interface in data communication with said processor;
a storage device in data communication with said processor,
and a software process operative to run on said processor, said software process comprising a plurality of instructions which are configured to, when executed;
register a first user profile associated with at least a first one of a plurality of identification information relating to a first user;
register a first property profile associated with said first user profile;
receive via said network entity a first one of said plurality of event data associated with said first property profile, wherein said first one of said plurality of event data, is collected by a second user, via said first user device by at least one data capture method; and
receive via said network entity a second one of said plurality of event data associated with said first property profile, wherein said second one of said plurality of event data is collected by a second user via the first user device by said at least one data capture method.

2. The apparatus of claim 1, wherein said at least first one of said plurality of identification information relating to said first user comprises an email address.

3. The apparatus of claim 1, wherein said at least first one of said plurality of identification information relating to said first user comprises a name.

4. The apparatus of claim 1, wherein said at least first one of said plurality of identification information relating to said first user comprises a phone number.

5. The apparatus of claim 2, wherein said first user is a seller's real estate agent.

6. The apparatus of claim 5, wherein said second user is a buyer's real estate agent.

7. The apparatus of claim 6, wherein said first user device comprises a mobile device associated with said buyer's real estate agent.

8. The apparatus of claim 2, wherein said at least one network entity comprises an email server.

9. The apparatus of claim 1, wherein said first property profile comprises a first registered property associated with said first user.

10. The apparatus of claim 7, wherein said second property profile comprises a second registered property associated with said first user.

11. The apparatus of claim 1, wherein said first one of said plurality of event data comprises a check-in time associated with said second user visiting said first registered property associated with said first user.

12. The apparatus of claim 9, wherein said second one of said plurality of event data comprises a check-out time associated with said second user visiting said first registered property associated with said first user.

13. The apparatus of claim 1, wherein said first and second ones of said plurality of event data are received at said user apparatus via said network entity according to a set of user configurable rules.

14. The apparatus of claim 1, wherein said at least one data capture method comprises NFC.

15. The apparatus of claim 1, wherein said at least one data capture method comprises a QR code.

16. The apparatus of claim 1, wherein said at least one data capture method comprises an RFID tag.

17. A method of receiving a plurality of event data from at least a first user device via at least one network entity, said method comprising:
registering a first user profile associated with at least a first one of a plurality of identification information relating to a first user;
registering a first property profile associated with said first user profile;
receiving at said storage device via said network entity a first one of said plurality of event data associated with said first property profile, wherein said first one of said plurality of event data, is collected by a second user, via said first user device by at least one data capture method; and
receiving at said storage device via said network entity a second one of said plurality of event data associated with said first property profile, wherein said second one of said plurality of event data is collected by a second user via the first user device by said at least one data capture method.

18. The method of claim 17, wherein said at least first one of said plurality of identification information relating to said first user comprises an email address.

19. The method of claim 18, wherein said first one of said plurality of event data comprises a check-in time associated with said second user visiting said first registered property associated with said first user.

20. The method of claim 19, wherein said second one of said plurality of event data comprises a check-out time associated with said second user visiting said first registered property associated with said first user.
